(19) United States
(12) Patent Application Publication
(10) Pub. No.: US 2023/0206193 A1
(43) Pub. Date: Jun. 29, 2023

(54) METHOD AND SYSTEM OF GENERATING PROOF OF PROVENANCE OF DIGITAL RECEIPT

(71) Applicant: MASTERCARD INTERNATIONAL INCORPORATED, Purchase, NY (US)

(72) Inventor: Rahul DESHPANDE, Chesterfield, MO (US)

(73) Assignee: MASTERCARD INTERNATIONAL INCORPORATED, Purchase, NY (US)

(21) Appl. No.: 17/563,270

(22) Filed: Dec. 28, 2021

(51) Int. Cl. G06Q 20/04

(52) U.S. Cl. CPC G06Q 20/047

(57) ABSTRACT

A method for establishing an immutable record of proof of provenance of a digital receipt using blockchain includes: receiving, by a receiver of a computing device, at least a product identifier for each of one or more products; generating, by a processor of the computing device, a data object comprising a digital receipt including at least the product identifier for each of the one or more products; transmitting, by a transmitter of the computing device, the generated data object to a blockchain node in a blockchain network; receiving, by the receiver of the computing device, a notification message from the blockchain node indicating successful addition of a new blockchain data entry in a blockchain associated with the blockchain network, the new blockchain data entry including at least the generated data object; and transmitting, by the transmitter of the computing device, the generated data object to a user device.

### FIELD

The present disclosure relates to generating proof of provenance of a product via a digital receipt, specifically the establishing of an immutable record of the proof of provenance of the digital receipt through the use of a blockchain.

### BACKGROUND

Traditionally, a consumer with a desire to purchase a product would physically go to a merchant and exchange currency for a physical good or service. If a case arose where the consumer would need to return or exchange the product, the consumer would have to provide proof that they purchased that same product from that same merchant. To fulfill this need, merchants issued physical receipts to consumers, which served as a record of the transaction including the time, date, amount paid, and the product or products that were purchased as part of the transaction.

In more modern times, a vast number of transactions between consumer and merchant are conducted electronically, such as via the Internet, application programs, automated kiosks, etc. In these types of transactions, the production and distribution of a physical receipt is inconvenient, if not impossible. As a result, consumers are typically provided with an electronic form of receipt, such as via a text message or electronic mail.

However, with the sophistication of computing technology, confirmation e-mails and text messages can be easily fabricated. In cases where a consumer is purchasing a product secondhand or from a reseller, the consumer can request proof of the original purchase to verify the authenticity of a product and ask for the receipt. In other cases, receipts may be used to obtain reimbursement or refunds for products or services that were not actually purchased. Because of the prevalence of fabricated electronic receipts, a receipt can be easily produced for the consumer, but the consumer can be wary of the legitimacy of the electronic receipt. Thus, there is a need for a system to provide a digital receipt for a product where the provenance of the digital receipt can be established and independently verified to prevent fraud.

### SUMMARY

The present disclosure provides a description of systems and methods for establishing an immutable record of proof of provenance of a digital receipt using blockchain. When a merchant is conducting a transaction with a consumer, the merchant generates a digital receipt for the transaction that has details, including at least a product identifier, for each product being purchased in the transaction, as well as any other relevant data, such as a time, date, point of sale identifier, transaction amount, etc. Before providing the digital receipt to the consumer, the merchant provides the digital receipt to a node in a blockchain network. The digital receipt is included in a new blockchain data value that is included in a new block that is confirmed and added to the blockchain. The merchant then provides the digital receipt to the consumer. By having the digital receipt stored on the blockchain, there is an immutable record of the digital receipt that cannot be modified and can be used by the consumer as proof of the initial purchase that can be independently verified. As a result, if the consumer wants to resell the product to another party, the digital receipt can be provided to the other party and the consumer can refer the other party to the blockchain to verify that the digital receipt is authentic and legitimate. The result is an immutable proof of provenance of a digital receipt, which can prevent consumers, merchants, and other parties from entering into potentially fraudulent exchanges.

A method for establishing an immutable record of proof of provenance of a digital receipt using blockchain includes: receiving, by a receiver of a computing device, at least a product identifier for each of one or more products; generating, by a processor of the computing device, a data object comprising a digital receipt including at least the product identifier for each of the one or more products; transmitting, by a transmitter of the computing device, the generated data object to a blockchain node in a blockchain network; receiving, by the receiver of the computing device, a notification message from the blockchain node indicating successful addition of a new blockchain data entry in a blockchain associated with the blockchain network, the new blockchain data entry including at least the generated data object; and transmitting, by the transmitter of the computing device, the generated data object to a user device.

A system for establishing an immutable record of proof of provenance of a digital receipt using blockchain includes: a blockchain network including at least a blockchain node; a user device; and a computing device including a receiver receiving at least a product identifier for each of one or more products, a processor generating a data object comprising a digital receipt including at least the product identifier for each of the one or more products, and a transmitter transmitting the generated data object to the blockchain node, wherein the receiver of the computing device receives a notification message from the blockchain node indicating successful addition of a new blockchain data entry in a blockchain associated with the blockchain network, the new blockchain data entry including at least the generated data object, and the transmitter of the computing device transmits the generated data object to the user device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for establishing immutable proof of provenance of a digital receipt in accordance with exemplary embodiments.

FIG. 2 is a block diagram illustrating the computing device in the system of FIG. 1 for establishing immutable proof of provenance of a digital receipt in accordance with exemplary embodiments.

FIGS. 3A and 3B are a flow diagram illustrating a process for establishing an immutable proof of provenance of a digital receipt for a transaction in the system of FIG. 1 in accordance with exemplary embodiments.

FIG. 4 is a flow chart illustrating an exemplary method for establishing an immutable record of proof of provenance of a digital receipt using blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Generating Proof of Provenance of a Digital Receipt

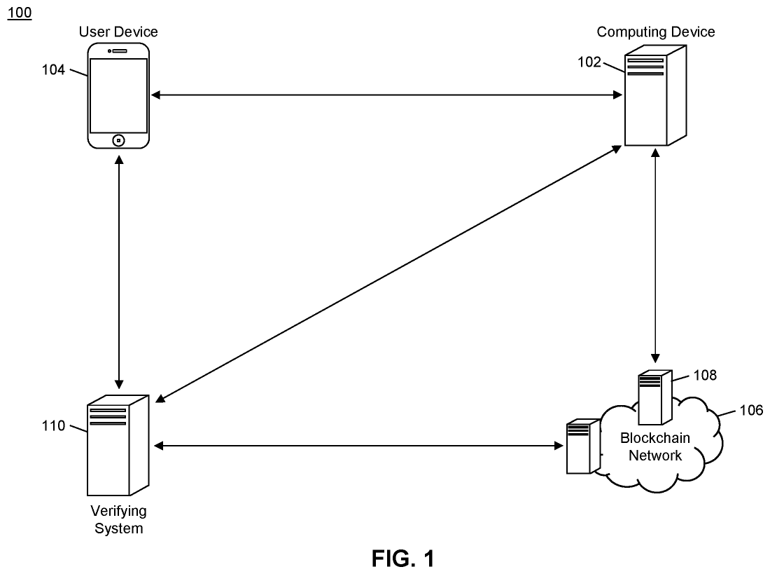

FIG. 1 illustrates a system 100 for establishing an immutable record for the proof of provenance of a digital receipt using blockchain.

The system 100 can include a computing device 102. The computing device 102, discussed in more detail below, can be configured to generate digital receipts for payment transactions or for any other transaction or exchange for which proof is desired. For example, the computing device 102 can be a point of sale device or system or a merchant that is involved in a transaction with a consumer for the purchase of one or more products (e.g., goods and/or services). The computing device 102 can be any type of device suitable to be specifically programmed for performing the functions discussed herein, such as a desktop computer, laptop computer, tablet, notebook computer, smart phone, server, etc.

In the system 100, the computing device 102 can receive data for one or more products to be purchased as part of a transaction. In cases where the transaction is a physical transaction (e.g., a consumer physically at a merchant location) product details can be received by the computing device 102 through an optical imaging device reading machine-readable codes (e.g., bar codes) displayed on the products that are encoded with product data, such as a product identifier (e.g., universal product code, stock keeping unit, International Standard Book Number, etc.) or through other suitable method, such as manual entry by a user (e.g., employee of the merchant) using a suitable input device (e.g., a keyboard, mouse, microphone, etc.). In cases where the transaction is an electronic transaction, the product details can be received by the computing device 102 from a second device, such as a user device 104. For instance, the user device 104 can interact with the computing device 104 via a web page, an application program, an application programming interface, or other suitable method. In an example, the user device 104 can be used to visit a web page of a merchant and make selections of products in an online shopping cart, where the computing device 102 can receive product data for the selections via traditional electronic commerce shopping methods. In another example, a consumer can use the user device 104 to read product details from machine-readable codes displayed on products and the user device 104 can electronically transmit the product data to the computing device 102 using a suitable communication network and method, such as via radio frequency, Bluetooth, local area network, etc. The user device 104 can be any type of computing device suitable for performing the functions discussed herein, such as a such as a desktop computer, laptop computer, tablet, notebook computer, smart phone, smart television, cellular phone, etc.

The computing device 102 can receive at least a product identifier for each product being purchased as part of the transaction. In some cases, the computing device 102 can receive additional data for some or each of the products, where such data can depend on the product being purchased. For instance, additional product data can include information regarding size, color, quantity, manufacturer, serial numbers, registration numbers, version numbers, manufacture dates, expiration dates, etc. Once the product data for each product has been received, the computing device 102 can calculate a total transaction amount to be paid for purchase of the selected product or products. The transaction amount can be presented to the consumer (e.g., via a display device interfaced with the computing device 102 for a physical transaction or by the user device 104 after transmission thereto by the computing device 102 for an electronic transaction). The consumer can then provide payment for the transaction using any suitable method. The computing device 102 can process the payment using suitable methods and confirm that the transaction is successfully conducted (e.g., sufficient payment made to cover the calculated transaction amount).

Following the transaction, the computing device 102 can generate a digital receipt for the transaction. The digital receipt can be a data object that is generated by the computing device 102 that contains data related to the transaction. The data object can be any suitable type of data object, such as a data file of any format suitable for use by the computing device 102 and/or user device 104. For example, the data object can be a text file formatted similar to a physical paper receipt, can be an image file generated to approximate the appearance of a digital scan of a physical paper receipt, a document file that includes a machine-readable code encoded with the data related to the transaction, etc. The data included in the data object can include at least the product identifier for each of the products purchased in the transaction. The data can also include any additional data as desired by the computing device 102 and/or user device 104, such as additional data for one or more of the products, transaction time, transaction date, merchant identifier, merchant name, geographic location, transaction type, currency type, transaction amount, payment method, issuer information, acquirer information, payment processor, transaction identifier, loyalty data, coupon data, reward data, a device identifier for the user device 104 (e.g., registration number, media access control address, e-mail address, telephone number, etc.), etc. In some cases, the consumer can request data for inclusion in the digital receipt, such as when submitting payment information.

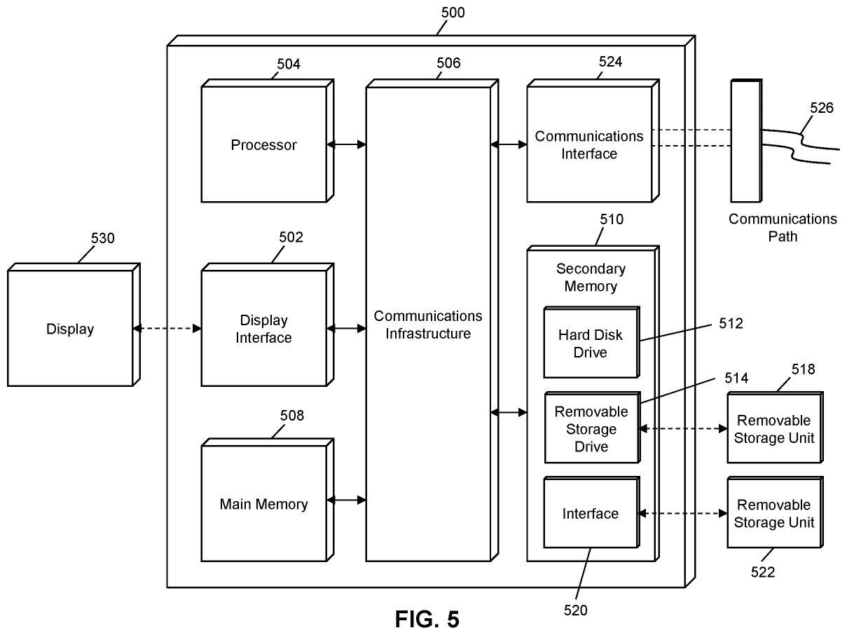

Once the data object comprising the digital receipt has been generated, the computing device 102 can electronically transmit the data object to a blockchain node 108 in a blockchain network 106 for addition to a blockchain associated therewith. The blockchain network 110 can be comprised of a plurality of blockchain nodes 108. Each blockchain node 108 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 108 in the blockchain network 106 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 106 using the public key of the cryptographic key pair. In some cases, the term “blockchain wallet” can refer specifically to the private key. In other cases, the term “blockchain wallet” can refer to a computing device (e.g., recipient device 106, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., the user device 104) that is generated using the sender's private key, a blockchain address of the recipient of currency (e.g., the computing device 102) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 108 in the blockchain network 106, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other nodes in the blockchain network 106 before being added to the blockchain and distributed to all of the blockchain nodes 108 in the blockchain network 106, respectively, in traditional blockchain implementations. In cases where a blockchain data value cannot be related to a blockchain transaction, but instead the storage of other types of data, blockchain data values can still include or otherwise involve the validation of a digital signature.

In the system 100, blockchain data values can be used to store digital receipts. A blockchain node 108 can receive the data object from the computing device 102, electronically transmitted thereto using a suitable communication network and method. The blockchain node 108 can generate a new blockchain data value that includes the data object, and include the new blockchain data value in a new block that is generated thereby for the blockchain. The new block can be transmitted to other blockchain nodes 108 in the blockchain network 106 for confirmation using traditional methods. Once the new block has been confirmed by a majority of blockchain nodes 108, the block can be added to the blockchain. In some embodiments, the blockchain node 108 can return a notification message to the computing device 102 to notify the computing device 102 of the successful addition of the data object to the blockchain. In some cases, each blockchain data value in the blockchain can have a unique identifier associated therewith, referred to herein as a blockchain identifier or blockchain data value identifier. In such cases, the notification message can include the unique identifier, which can be used by the computing device 102 to identify the blockchain data value in the new block to verify inclusion of the data object.

After the data object has been successfully added to the blockchain, the computing device 102 can electronically transmit the data object to the user device 104. The data object can be electronically transmitted to the user device 104 using any suitable communication network and method, which can be requested by the user device 104, such as indicated during a registration process by the consumer as a user thereof or provided during the transaction, such as with the payment data. For instance, for a physical transaction, the data object can be e-mailed to the user device 104 via an e-mail address provided during or prior to the transaction. In another example, for an electronic transaction, the data object can be transmitted to the user device 104 via an application program used by the consumer to conduct the transaction. In embodiments where the blockchain node 108 provides the computing device 102 with a unique identifier for the blockchain data value that includes the data object, the computing device 102 can provide the unique identifier to the user device 104 with the data object, such as for use by the user device 104 in verifying the inclusion of the data object on the blockchain.

Once the user device 104 has received the data object, the user of the user device 104 can utilize the data object in providing authenticity and verification of the transaction. For instance, the user of the user device 104 can have purchased a good from the merchant associated with the computing device 102 and be interested in reselling the good. The user can contact a third party for resale. The third party can be interested in verifying that the user purchased the good directly from the merchant, such as to verify the authenticity of the product or to ensure there was not additional ownership that can adversely affect the value of the item. The user device 104 can electronically transmit the data object comprising the digital receipt for the purchase of the good to a verifying system 110, which can be another computing device or computing system used by or on behalf of the third party. The verifying system 110 can receive the data object and can then look for inclusion of that data object on the blockchain associated with the blockchain network 106. In some cases, the blockchain can be publicly accessible, where the verifying system 110 can access the blockchain via the Internet or other suitable method and can then view blockchain data values to identify one that includes a data object that matches the data object received from the user device 104. In other cases, the blockchain can be permissioned or private. In such cases, the verifying system 110 can electronically transmit the data object to a blockchain node 108 or other permissioned system, which can identify inclusion of that data object in the blockchain, and provide a result to the verifying system 110 indicating if a match was or was not found.

If the data object is successfully identified as being in the blockchain, the verifying system 110 can verify that the data included in the data object in the blockchain matches the data included in the data object received from the user device 104, such as to ensure that the user device 104 was involved (e.g., via inclusion of a device identifier, a specified payment method, a matched with provided details, etc.) or to ensure that the good available for resale was included in the transaction. If the third party is satisfied with the results of the verification, the third party can go through with a transaction to purchase the good via resale.

In some embodiments, the computing device 102 can be configured to digitally sign digital receipts prior to inclusion on the blockchain. In such embodiments, the computing device 102 can possess a cryptographic key pair comprised of a public key and private key, such as can be used for a blockchain wallet. After the data object comprising a digital receipt is generated, the computing device 102 can digitally sign the data object using its private key and a suitable signature algorithm. The computing device 102 can electronically transmit the signed data object to the blockchain node 108 for inclusion in a new blockchain data value that is added to the blockchain via a new block. When an entity wants to verify the data object, such as the blockchain node 108, user device 104, or a verifying system 110, the entity can request the public key of the cryptographic key pair from the computing device 102. The entity can receive the public key and use the public key to verify the digital signature on the data object using the signature generation algorithm. If the verification is successful, the digital receipt is genuine from the computing device 102, and thus from the associated merchant or other entity. In such cases, a verifying system 110 can verify that a good being purchased through resale was bought from a known and trusted merchant, such as instead of a different merchant posing as the known and trusted merchant (e.g., using the same name or other data in the digital receipt). In these instances, the merchant associated with the computing device 102 can make the public key publicly available, such as on a website or via an application program associated with the merchant, to encourage consumers and others to verify the genuine purchase and provenance of products.

The methods and systems discussed herein provide for the establishment of an immutable proof of provenance for a digital receipt via the use of a blockchain. Digital receipts are generated by a merchant for any type of transaction and are then stored on a blockchain, and can be further digitally signed by the merchant for additional verification. The digital receipt is provided to the consumer involved in the transaction, which can be used by the consumer to verify that the transaction occurred and the product(s) purchased in the transaction for any reasons. Additionally, because the blockchain is immutable, any attempt at modifying the digital receipt can be found out by any interested party, such as a third party that is purchasing the product(s) secondhand from the consumer. As a result, the methods and systems discussed herein provide for electronic and digital receipts that are strongly resistant to fraud without the need for significant modifications to merchant and consumer systems via the use of a blockchain.

### Computing Device

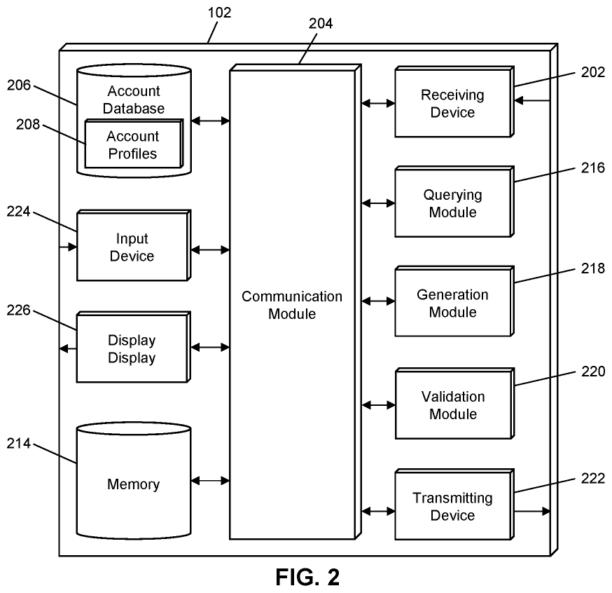

FIG. 2 illustrates an embodiment of the computing device 102 in the system 100. It will be apparent to persons having skill in the relevant art that the embodiment of the computing device 102 illustrated in FIG. 2 is provided as illustration only and cannot be exhaustive to all possible configurations of the computing device 102 suitable for performing the functions as discussed herein. For example, the computer system 500 illustrated in FIG. 5 and discussed in more detail below can be a suitable configuration of the computing device 102. Additional components in the system 100, such as user device 104, blockchain node 108, and verifying system 110 can include components illustrated in FIG. 2 and discussed below.

The computing device 102 can include a receiving device 202. The receiving device 202 can be configured to receive data over one or more networks via one or more network protocols. In some instances, the receiving device 202 can be configured to receive data from user devices 104, blockchain nodes 108, verifying systems 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by user devices 104 that are superimposed or otherwise encoded with payment data, product data, requested fields for digital receipts, public key requests, contact information, etc. The receiving device 202 can also be configured to receive data signals electronically transmitted by blockchain nodes 108, which can be superimposed or otherwise encoded with blockchain data values, unique identifiers, new blocks, blockchain data, etc. The receiving device 202 can be further configured to receive data signals electronically transmitted by verifying systems 110 that can be superimposed or otherwise encoded with public key requests, data objects, signed data objects, etc.

The computing device 102 can also include a communication module 204. The communication module 204 can be configured to transmit data between modules, engines, databases, memories, and other components of the computing device 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the computing device 102 and external components of the computing device 102, such as externally connected databases, display devices, input devices, etc. The computing device 102 can also include a processing device. The processing device can be configured to perform the functions of the computing device 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, verification module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The computing device 102 can include an account database 206. The account database 206 can be configured to store a plurality of account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to one or more consumers and/or associated user devices 104. For example, a consumer can establish an account with the merchant associated with the computing device 102, where their account profile can include payment data, data objects comprising digital receipts for past transactions, preferences for data object fields, communication data, loyalty data, reward data, shipping information, product preferences, warranty data, etc.

The computing device 102 can also include a memory 214. The memory 214 can be configured to store data for use by the computing device 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the computing device 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, communication information, data formatting rules, blockchain data, signature generation algorithms, account information, etc.

The computing device 102 can include a querying module 216. The querying module 216 can be configured to execute queries on databases to identify information. The querying module 216 can receive one or more data values or query strings, and can execute a query string based thereon on an indicated database, such as the memory 212 of the computing device 102 to identify information stored therein. The querying module 216 can then output the identified information to an appropriate engine or module of the computing device 102 as necessary. The querying module 216 can, for example, execute a query on the account database 206 to identify an account profile 208 for a consumer involved in a new transaction, such as via a username and password provided by the user device 104, to identify preferences for fields to be included in a digital receipt generated for a new transaction.

The computing device 102 can also include a generation module 218. The generation module 218 can be configured to generate data for use by the computing device 102 in performing the functions discussed herein. The generation module 218 can receive instructions as input, can generate data based on the instructions, and can output the generated data to one or more modules of the computing device 102. For example, the generation module 218 can be configured to generate notification messages, confirmation messages, digital signatures, machine readable codes, transaction amounts, data objects, digital receipts, etc.

The computing device 102 can also include a validation module 220. The validation module 220 can be configured to perform validations for the computing device 102 as part of the functions discussed herein. The validation module 220 can receive instructions as input, which can also include data to be used in performing a validation, can perform a validation as requested, and can output a result of the validation to another module or engine of the computing device 102. The validation module 220 can, for example, be configured to validate digital signatures using suitable signature generation algorithms and keys, validate data objects and/or data included therein, etc.

The computing device 102 can also include a transmitting device 222. The transmitting device 222 can be configured to transmit data over one or more networks via one or more network protocols. In some instances, the transmitting device 222 can be configured to transmit data to user devices 104, blockchain nodes 108, verifying systems 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to user devices 104 that are superimposed or otherwise encoded with data objects, signed data objects, transaction amounts, transaction data, product data, verification results, public keys, etc. The transmitting device 222 can also be configured to electronically transmit data signals to blockchain nodes 108, which can be superimposed or otherwise encoded with data objects, signed data objects, public keys, blockchain data values, unique identifiers, requests for unique identifiers, etc. The transmitting device 222 can be further configured to electronically transmit data signals to verifying systems 110 that can be superimposed or otherwise encoded with data objects, signed data objects, public keys, verification results, etc.

The computing device 102 can also include an input device 224. The input device 224 can be any type of device suitable for capturing input from a user of the computing device 102 or any other device or item (e.g., a product) using any suitable method. The input device 224 can be, for example, a keyboard, mouse, capacitive touch screen, trackpad, click wheel, microphone, camera, optical imaging device, etc. The input device 224 can be configured to receive user instructions, received other data input by a user (e.g., payment data, product data, preferences, etc.), read machine-readable codes, etc. The input device 224 can be directly connected to the computing device 102, such as internally, or can be otherwise interfaced therewith, such as through one or more external cables or wirelessly using a suitable communication network and method.

The computing device 102 can also include a display device 226. The display device 226 can be any type of device suitable for displaying data to a user of the computing device 102 using any suitable method. The display device 226 can be, for example, a monitor, capacitive touch screen, thin film transistor display, liquid crystal display, light emitting diode display, etc. The display device 226 can be configured to display product data, transaction amounts, data objects, etc. The display device 226 can be directly connected to the computing device 102, such as internally, or can be otherwise interfaced therewith, such as through one or more external cables or wirelessly using a suitable communication network and method.

### Process for Generating Proof of Provenance for a Digital Receipt

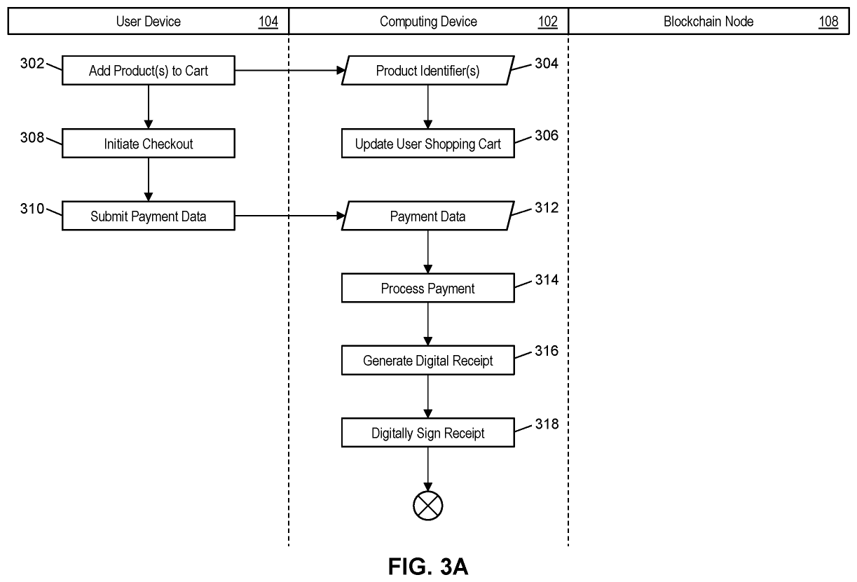

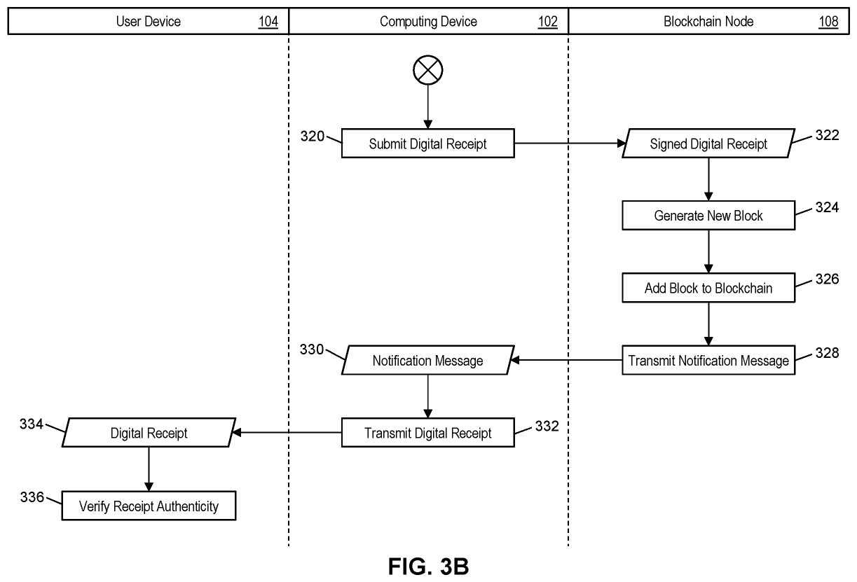

FIGS. 3A and 3B illustrate a process for generating proof of provenance for a digital receipt for an electronic transaction through use of a blockchain in the system 100 of FIG. 1.

In step 302, the user device 104 can add (e.g., as a result of instructions from user input) one or more products to a shopping cart for purchase through an electronic commerce transaction via a website of a merchant associated with the computing device 102. Each time a product is added to the shopping cart, a product identifier for the product can be electronically transmitted to the computing device 102 via a suitable communication network and method. In step 304, the receiving device 202 of the computing device 102 can receive the product identifier. In step 306, the querying module 216 of the computing device 102 can execute a query on the account database 206 of the computing device 102 to add the product identifier to a shopping cart associated with the user device 104, such as in an account profile 208 associated with the user device 104. In some cases, step 306 can include updating a transaction amount for the transaction that is displayed to the user of the user device 104 via a display device thereof.

Once the user of the user device 104 is satisfied with their selection of products, in step 308, the user device 104 can initiate a checkout process on their web browser via interacting with a button or other interactable object. As part of the checkout process, the user can be prompted to enter payment data associated with a transaction account for use in funding an electronic payment transaction for purchase of the selected product(s). The user device 104 can collect the payment data and any other suitable information (e.g., shipping information, billing address, requested fields for a digital receipt, etc.) and can, in step 310, electronically transmit the payment data and other data to the computing device 102, such as through a form on the website being accessed by the user device 104.

In step 312, the receiving device 202 of the computing device 102 can receive the payment data from the user device 104, along with any other accompanying data. In step 314, the computing device 102 can process an electronic payment transaction for payment from the transaction account associated with the payment data submitted by the user device 104 to a transaction account associated with the merchant for a transaction amount based on costs of the product(s) selected for purchased and any applicable taxes and fees. Once the payment transaction is successfully authorized, the generation module 218 of the computing device 102 can, in step 316, generate a data object comprising a digital receipt for the transaction. The data object can include at least the product identifier for each of the selected products purchased in the transaction, and can include any additional data as desired by the computing device 102 and/or the user device 104, such as additional product details, time, date, geographic location, device identifier for the user device 104, device identifier for the computing device 102, transaction type, payment method, currency, transaction amount, etc. In step 318, the generation module 218 of the computing device 102 can digitally sign the data object using a private key of a cryptographic key pair of the computing device 102 (e.g., stored in the memory 214 of the computing device 102).

In step 320, the transmitting device 222 of the computing device 102 can electronically transmit the signed data object to a blockchain node 108 in the blockchain network 106 using a suitable communication network and method. In step 322, the blockchain node 108 can receive the signed data object. In some embodiments, the blockchain node 108 can verify the digital signature of the data object using a public key of the computing device's cryptographic key pair, which can have accompanied the signed data object or been previously provided to the blockchain node 108, such as via a registration process. In step 324, the blockchain node 108 can generate a new blockchain data value that includes the signed data object and can generate a new block that includes the blockchain data value and can include one or more additional blockchain data values. In some embodiments, a unique identifier can be generated for and included in the new blockchain data value. In step 326, the new block can be added to the blockchain via a traditional confirmation process in the blockchain network 106.

In step 328, the blockchain node 108 can electronically transmit a notification message to the computing device 102. The notification message can indicate that the signed data object was successfully added to the blockchain. In cases where a unique identifier was included in the new blockchain data value that included the signed data object, the notification message can include the unique identifier. In step 330, the receiving device 202 of the computing device 102 can receive the notification message from the blockchain node 108. In step 332, the transmitting device 222 of the computing device 102 can electronically transmit the data object comprising the digital receipt to the user device 104 using a suitable communication network and method. In some cases, the signed data object can be transmitted to the user device 104. In instances where a unique identifier was provided to the computing device 102 by the blockchain node 108, the unique identifier can be forwarded to the user device 104 with the data object.

In step 334, the user device 104 can receive the data object from the computing device 102, which can be stored in a memory thereof and can be displayed to the user of the user device 104. In step 336, the user device 104 can verify the authenticity of the digital receipt, such as by verifying inclusion of the data object in a blockchain data value in the blockchain. In cases where the data object stored in the blockchain is digitally signed, the user device 104 can receive the public key of the computing device's cryptographic key pair and can verify the digital signature of the data object in the blockchain using the public key as part of the verification process.

### Exemplary Method for Establishing an Immutable Record for a Digital Receipt

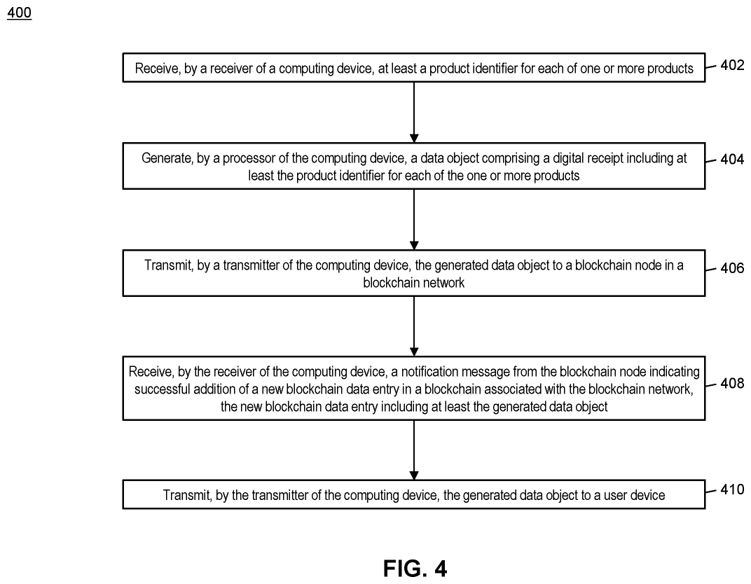

FIG. 4 illustrates a method 400 for establishing an immutable record of proof of provenance of a digital receipt using a blockchain.

In step 402, at least a product identifier for each of one or more products can be received by a receiver (e.g., receiving device 202) of a computing device (e.g., computing device 102). In step 404, a data object comprising a digital receipt can be generated by a processor (e.g., generation module 218) of the computing device, the digital receipt including at least the product identifier for each of the one or more products. In step 406, the generated data object can be transmitted by a transmitter (e.g., transmitting device 222) of the computing device to a blockchain node (e.g., blockchain node 108) in a blockchain network (e.g., blockchain network 106). In step 408, a notification message can be received from the blockchain node by the receiver of the computing device that indicates successful addition of a new blockchain data entry in a blockchain associated with the blockchain network, the new blockchain data entry including at least the generated data object. In step 410, the generated data object can be transmitted by a transmitter of the computing device to a user device (e.g., user device 104).

In one embodiment, the digital receipt can further include at least one of: a merchant identifier, a transaction amount, a time, a date, a geographic location, and a point of sale identifier. In some embodiments, receiving the product identifier for one or more products can include reading, with an optical imaging device (e.g., input device 224), a machine readable code displayed on each of the one or more products encoded with the respective product identifier. In one embodiment, the product identifier for each of the one or more products can be received as a result of one or more actions performed using the user device. In some embodiments, the method 400 can further include: storing, in a memory (e.g., memory 214) of the computing device, a cryptographic key pair including a public key and a private key; and digitally signing, by the processor (e.g., generation module 218) of the computing device, the generated data object using the private key, wherein the digital signature can be transmitted to the blockchain node with the generated data object, and the digital signature can be included in the new blockchain data entry.

In one embodiment, the notification message can include a blockchain identification value. In a further embodiment, the blockchain identification value can be transmitted to the user device with the generated data object. In another further embodiment, the method 400 can further include adding, by the processor of the computing device, the blockchain identification value to the generated data object before transmitting the generated data object to the user device.

### Computer System Architecture

FIG. 5 illustrates a computer system 500 in which embodiments of the present disclosure, or portions thereof, can be implemented as computer-readable code. For example, computing device 102 of FIGS. 1 and 2 and the user device 104, blockchain node 108, and verifying system 110 of FIG. 1 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for establishing an immutable record of proof of provenance of a digital receipt using blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

1. A method for establishing an immutable record of proof of provenance of a digital receipt using blockchain, comprising:
receiving, by a receiver of a point-of-sale (POS) device of a merchant, at least a product identifier for each of one or more products as part of a transaction between the merchant and a user;
generating, by a processor of the POS device, a data object comprising a digital receipt including at least the product identifier for each of the one or more products, wherein the generated data object is a document file that includes a machine-readable code encoded with at least the digital receipt for the transaction;
transmitting, by a transmitter of the POS device, the generated data object to a blockchain node in a blockchain network where a new blockchain data entry is added in a blockchain associated with the blockchain network, the new blockchain data entry including at least the generated data object;
upon successful addition of the new blockchain data entry in the blockchain, receiving, by the receiver of the POS device, a notification message from the blockchain node indicating successful addition of the new blockchain data entry in the blockchain; and
once the POS device is notified that the new blockchain data entry has been successfully added to the blockchain, transmitting, by the transmitter of the POS device, the generated data object including the digital receipt to a user device of the user.

2. The method of claim 1, wherein the digital receipt further includes at least one of: a merchant identifier, a transaction amount, a time, a date, a geographic location, and a point of sale identifier.

3. The method of claim 1, wherein receiving the product identifier for one or more products includes reading, with an optical imaging device, a machine readable code displayed on each of the one or more products encoded with the respective product identifier.

4. The method of claim 1, wherein the product identifier for each of the one or more products is received as a result of one or more actions performed using the user device.

5. The method of claim 1, wherein the notification message includes a blockchain identification value.

6. The method of claim 5, wherein the blockchain identification value is transmitted to the user device with the generated data object.

7. The method of claim 5, further comprising:
adding, by the processor of the POS device, the blockchain identification value to the generated data object before transmitting the generated data object to the user device.

8. The method of claim 1, further comprising:
storing, in a memory of the POS device, a cryptographic key pair including a public key and a private key; and
digitally signing, by the processor of the POS device, the generated data object using the private key, wherein
the digital signature is transmitted to the blockchain node with the generated data object, and
the digital signature is included in the new blockchain data entry.

9. A system for establishing an immutable record of proof of provenance of a digital receipt using blockchain, comprising:
a blockchain network including at least a blockchain node;
a user device; and
a point-of-sale (POS) device of a merchant including
a receiver receiving at least a product identifier for each of one or more products as part of a transaction between the merchant and a user of the user device,
a processor generating a data object comprising a digital receipt including at least the product identifier for each of the one or more products, wherein the generated data object is a document file that includes a machine-readable code encoded with at least the digital receipt for the transaction, and
a transmitter transmitting the generated data object to the blockchain node where a new blockchain data entry is added in a blockchain associated with the blockchain network, the new blockchain data entry including at least the generated data object, wherein
upon successful addition of the new blockchain data entry in the blockchain, the receiver of the POS device receives a notification message from the blockchain node indicating successful addition of the new blockchain data entry in the blockchain, and
once the POS device is notified that the new blockchain data entry has been successfully added to the blockchain, the transmitter of the POS device transmits the generated data object including the digital receipt to the user device of the user.

10. The system of claim 9, wherein the digital receipt further includes at least one of: a merchant identifier, a transaction amount, a time, a date, a geographic location, and a point of sale identifier.

11. The system of claim 9, wherein receiving the product identifier for one or more products includes reading, with an optical imaging device, a machine readable code displayed on each of the one or more products encoded with the respective product identifier.

12. The system of claim 9, wherein the product identifier for each of the one or more products is received as a result of one or more actions performed using the user device.

13. The method of claim 9, wherein the notification message includes a blockchain identification value.

14. The system of claim 13, wherein the blockchain identification value is transmitted to the user device with the generated data object.

15. The system of claim 13, wherein the processor of the POS device adds the blockchain identification value to the generated data object before the generated data object is transmitted to the user device.

16. The system of claim 9, wherein
the POS device further includes a memory storing a cryptographic key pair including a public key and a private key,
the processor of the POS device digitally signs the generated data object using the private key,
the digital signature is transmitted to the blockchain node with the generated data object, and
the digital signature is included in the new blockchain data entry.
